(19) United States
(12) Patent Application Publication
(10) Pub. No.: US 2004/0012678 A1
(43) Pub. Date: Jan. 22, 2004

(54) Electric power line network video camera device for processing images and signals

(76) Inventor: Tung-Liang Li, Tainan (TW)

Correspondence Address: Alan D. Kamrath, Rider, Bennett, Egan & Arundel. LLP, Suite 2000, 333 South Seventh Street, Minneapolis, MN, 55402, US

(21) Appl. No.: 10/196,317

(22) Filed: Jul. 16, 2002

(51) Int. Cl. H04N 5/225

(52) U.S. Cl. 348/207.99

(57) ABSTRACT

An electric power line network video camera device for processing images and signals includes a video camera, a physical signal unit, an IA unit, a main processor, an electric power line network unit, and a control monitor. The main processor may be used to store and process images and signals from the video camera, the physical signal unit and the IA unit, and includes an I/O analogue/digital unit, and an embedded system. The I/O analogue/digital unit may be used to record information and data entering the main processor. The embedded system may be used to process and analyze the images and signals stored by the I/O analogue/digital unit.

### BACKGROUND OF THE INVENTION

The present invention relates to an electric power line network video camera device for processing images and signals, and more particularly to an electric power line network video camera device for processing images and signals, wherein the main processor may be used to store and process the images and signals from the video camera, the physical signal unit and the IA unit, and the electric power line network unit may be used to convert and transfer the data of the processed images and signals stored in the main processor to the control monitor, so that the energy of the electric power may be employed efficiently.

### SUMMARY OF THE INVENTION

The primary objective of the present invention is to provide a electric power line network video camera device for processing images and signals, wherein the main processor may be used to store and process the images and signals from the video camera, the physical signal unit and the IA unit, and the electric power line network unit may be used to convert and transfer the data of the processed images and signals stored in the main processor to the control monitor, so that the energy of the electric power may be employed efficiently.

Another objective of the present invention is to provide a electric power line network video camera device for processing images and signals, wherein the electric power line network unit may enhance the remote inspection and monitoring effect.

A further objective of the present invention is to provide a electric power line network video camera device for processing images and signals, wherein the I/O analogue/digital unit and the embedded system of the main processor may enhance the effect of the main processor exactly.

In accordance with the present invention, there is provided an electric power line network video camera device for processing images and signals, comprising a video camera, a physical signal unit, an IA unit, a main processor, an electric power line network unit, and a control monitor, wherein:

the main processor may be used to store and process images and signals from the video camera, the physical signal unit and the IA unit;

the main processor includes an I/O analogue/digital unit, and an embedded system;

the I/O analogue/digital unit may be used to record information and data entering the main processor; and

the embedded system may be used to process and analyze the images and signals stored by the I/O analogue/digital unit.

Thus, the main processor may store and process the images obtained from the remote video camera, the physical signals (including the pulse number, the blood oxygen concentration, the body temperature, the electrocardiogram data) of the physical signal unit measured and recorded by a medical instrument, and the signals (from the information appliance, the network appliance) received by the IA unit, while the electric power line network unit may convert and transfer the data of the processed images and signals stored in the main processor to the control monitor.

Further benefits and advantages of the present invention will become apparent after a careful reading of the detailed description with appropriate reference to the accompanying drawings.

### BRIEF DESCRIPTION OF THE DRAWINGS

FIG. 1 is a block view of an electric power line network video camera device for processing images and signals in accordance with a preferred embodiment of the present invention.

### DETAILED DESCRIPTION OF THE INVENTION

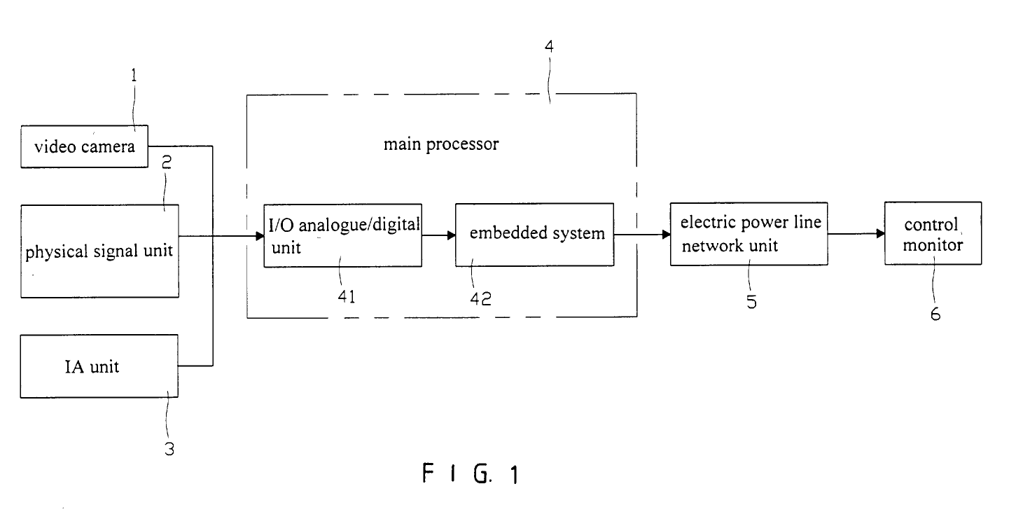

Referring to FIG. 1, an electric power line network video camera device for processing images and signals in accordance with a preferred embodiment of the present invention comprises a video camera 1, a physical signal unit 2, an IA unit 3, a main processor 4, an electric power line network unit 5, and a control monitor 6.

The video camera 1 may be used to obtain the images.

The physical signal unit 2 contains multiple physical signals that may be measured and recorded by a medical instrument, including the pulse number, the blood oxygen concentration (SPO₂), the body temperature, the electrocardiogram data and the like.

The IA unit 3 may be used to receive the signals from the information appliance, the network appliance and the like.

The main processor 4 includes an I/O analogue/digital unit 41, and an embedded system 42. The main processor 4 may be used to store and process the images and signals from the video camera 1, the physical signal unit 2 and the IA unit 3. In practice, the I/O analogue/digital unit 41 may be used to record the information and data entering the main processor 4. In addition, the embedded system 42 may be used to process and analyze the images and signals stored by the I/O analogue/digital unit 41.

The electric power line network unit 5 may be used to convert and transfer the data of the processed images and signals stored in the main processor 4.

The control monitor 6 may be used to indicate the processed images and signals transferred by the electric power line network unit 5.

Accordingly, the electric power line network video camera device for processing images and signals in accordance with a preferred embodiment of the present invention has the following advantages.

1. The main processor 4 may be used to store and process the images and signals from the video camera 1, the physical signal unit 2 and the IA unit 3, and the electric power line network unit 5 may be used to convert and transfer the data of the processed images and signals stored in the main processor 4 to the control monitor 6, so that the energy of the electric power may be employed efficiently.

2. The electric power line network unit 5 may enhance the remote inspection and monitoring effect.

3. The I/O analogue/digital unit 41 and the embedded system 42 of the main processor 4 may enhance the effect of the main processor 4 exactly.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An electric power line network video camera device for processing images and signals, comprising a video camera, a physical signal unit, an IA unit, a main processor, an electric power line network unit, and a control monitor, wherein:
the main processor may be used to store and process images and signals from the video camera, the physical signal unit and the IA unit;
the main processor includes an I/O analogue/digital unit, and an embedded system;
the I/O analogue/digital unit may be used to record information and data entering the main processor; and
the embedded system may be used to process and analyze the images and signals stored by the I/O analogue/digital unit.

2. The electric power line network video camera device for processing images and signals in accordance with claim 1, wherein the video camera may be used to obtain images.

3. The electric power line network video camera device for processing images and signals in accordance with claim 1, wherein the physical signal unit contains multiple physical signals that may be measured and recorded by a medical instrument, and the multiple physical signals of the physical signal unit include a pulse number, a blood oxygen concentration, a body temperature, and electrocardiogram data.

4. The electric power line network video camera device for processing images and signals in accordance with claim 1, wherein the IA unit may be used to receive signals from an information appliance and a network appliance.

5. The electric power line network video camera device for processing images and signals in accordance with claim 1, wherein the electric power line network unit may be used to convert and transfer the data of the processed images and signals stored in the main processor.

6. The electric power line network video camera device for processing images and signals in accordance with claim 1, wherein the control monitor may be used to indicate the processed images and signals transferred by the electric power line network unit.
